(19) United States
(12) Patent Application Publication
(10) Pub. No.: US 2026/0110148 A1
(43) Pub. Date: Apr. 23, 2026

(54) Roadside Litter Collecting Apparatus

(71) Applicant: Littertech UK Limited, Kilkeel (GB)

(72) Inventor: Thomas Forbes, Carlingford (IE)

(21) Appl. No.: 19/160,085

(22) PCT Filed: Mar. 1, 2023
(86) PCT No.: PCT/EP2023/055194

§ 371 Date: Aug. 27, 2025

(51) Int. Cl. E01H 1/08; B07C 5/342; B07C 5/36; E01H 1/00

(52) U.S. Cl. CPC E01H 1/0836; B07C 5/342; B07C 5/367; E01H 1/003; B07C 2501/0054

(57) ABSTRACT

A roadside litter collecting apparatus has a frame or chassis upon which is mounted a pneumatic litter pick-up apparatus which includes a flexible suction pipe for delivery of litter contaminated roadside material to a settlement tank. The litter contaminated roadside material is discharged from the settlement tank and is spread out on a sorting conveyor. A camera mounted above the sorting conveyor is operable to detect litter within the litter contaminated roadside material on the sorting conveyor and an associated pick-up arm is operable in response to the camera to grab litter detected by the camera and deposit the litter into a litter bin located beneath the sorting conveyor. The cleaned roadside material is returned to the roadside, and at the same time another batch of litter contaminated roadside material is discharged from the settlement tank onto the sorting conveyor to repeat the sorting process.

### REFERENCE TO RELATED APPLICATIONS

This application is a national phase to PCT Application No. PCT/EP2023/055194 filed Mar. 1, 2023 entitled Roadside Litter Collecting Apparatus which is incorporated in its entirety herein by reference thereto.

### FEDERALLY SPONSORED RESEARCH AND DEVELOPMENT

None.

### FIELD OF THE INVENTION

This invention relates to a roadside litter collecting apparatus wherein the term “litter” as used in this patent specification includes any litter, thrash, rubbish, waste materials, debris and the like unwanted material which may be scattered alongside a roadway.

### BACKGROUND OF THE INVENTION

Typically, roadside litter is mixed with natural roadside materials such as small stones, gravel and organic material such as verge trimming and hedge trimming materials, including grass, leaves and the like. Currently, it is common to manually pick litter from the roadside which is relatively expensive and requires a considerable number of workers to walk alongside the verge collecting the litter. This is also dangerous for the workers, particularly alongside motorways and highways.

Various litter collecting and road cleaning vehicles are known. For example, Swedish Patent Publication No. SE 451207B discloses a composite road material recycling machine which collects road edge material which is separated to remove gravel which is returned to the roadside and rubbish is collected separately for removal. Another road-cleaning vehicle is disclosed in U.S. Pat. No. 4,885,817 having a pneumatic pick-up head for collecting rubbish which is delivered to a rubbish hopper. Dust is then separated from the air used to pick up the rubbish. Various other trash collecting and road cleaning vehicles are disclosed in U.S. Pat. No. 4,643,776, China Patent No. 2,641,119, and German Patent Application No. 2501363, for example.

### SUMMARY OF THE INVENTION

According to the invention, there is provided a roadside litter collecting apparatus, comprising a litter pick-up apparatus to collect litter contaminated roadside material from a roadside for delivery to a sorting station, the sorting station having a litter separator which is operable to separate litter from the roadside material, deliver the litter to a litter bin and return the roadside material to the roadside, wherein the litter separator has a camera which is operable to detect litter within the litter contaminated roadside material, and an associated litter pick-up arm which is operable in response to the camera to grab detected litter and deposit the litter in the litter bin.

In one embodiment of the invention, the litter separator has a separator conveyor having an inlet end for reception of the litter contaminated roadside material from the litter pick-up apparatus, and an outlet end which discharges roadside material to a return conveyor for discharging roadside material back to the roadside.

In another embodiment, a plurality of lamps are mounted at opposite sides of the separator conveyor for illuminating material on the separator conveyor.

In another embodiment, the separator conveyor is an indexing conveyor.

In another embodiment, the litter pick-up apparatus comprises a pneumatic pick-up pipe having an inner end which discharges into a settlement tank and a movable outer end with a pick-up head, a fan having an inlet connected to the settlement tank to apply suction to the pick-up pipe, the settlement tank having an outlet for the litter contaminated roadside material communicating with an inlet of the litter separator.

In another embodiment, the settlement tank outlet communicates with the inlet of the litter separator through an airlock.

In another embodiment, the airlock has a cylindrical housing, a central driveshaft rotatably mounted within the housing and having a plurality of circumferentially spaced-apart radial vanes, an outer end of each vane sealingly engaging against an inner face of the cylindrical housing to provide an airtight seal therewith.

In another embodiment, an air suction chamber is provided in the settlement tank above the inlet end of the pneumatic pick-up pipe behind a partition wall having a plurality of spaced-apart air inlet openings, an air outlet of the air suction chamber communicating with the inlet of the fan.

In another embodiment, the separator conveyor is movable between an operating position for reception of the litter contaminated roadside material from the settlement tank and an inoperative position wherein the litter contaminated roadside material bypasses the separator conveyor.

In another embodiment, the separator conveyor is slidably mounted on top of the litter bin for movement between the operating position and the inoperative position.

In another embodiment, the inner end of the pneumatic pick-up pipe extends into the settlement tank and has a number of spaced-apart vent slots in a side wall of the inner end within the settlement tank.

In another embodiment, the pick-up head is telescopically mounted at the outer end of the pneumatic pick-up pipe.

In another embodiment, the pick-up head is rotatably mounted at the outer end of the pneumatic pick-up pipe.

In another embodiment, the pick-up head has a skirt of resilient material with an opening in a side of the skirt for feeding the litter contaminated roadside material into the pneumatic pick-up pipe.

In another embodiment, an air vent is mounted on the pneumatic pick-up pipe which is operable to reduce suction in the pneumatic pick-up pipe.

In another embodiment, the litter bin is pivotally mounted on a support frame for pivotal movement between a lowered collecting position and a tilted discharge position.

In another embodiment, a compactor is movable through the litter bin to compact waste collected within the litter bin.

In another embodiment, the litter bin is mounted beneath the separator conveyor and projects laterally outwardly therefrom to provide a litter inlet opening at a top of the litter bin.

In another embodiment, the settlement tank is mounted on top of the litter bin.

In another embodiment, the roadside litter collecting apparatus is mounted on a mobile chassis.

### BRIEF DESCRIPTION OF THE DRAWINGS

The invention will be more clearly understood from the following description of some embodiments thereof, given by way of example only, with reference to the accompanying drawings.

FIG. 1 is a perspective view of roadside litter collecting apparatus according to the invention.

FIG. 2 is a sectional elevational view of the roadside litter collecting apparatus.

FIG. 3 is a detail perspective view of a settlement tank forming portion of the roadside litter collecting apparatus.

FIG. 4 is a detail perspective view of a litter pick-up head forming portion of the roadside litter collecting apparatus.

### DETAILED DESCRIPTION

Referring to the drawings, there is illustrated a roadside litter collecting apparatus according to the invention, indicated generally by the reference numeral 1. The apparatus 1 has a frame or chassis 2 upon which is mounted a pneumatic litter pick-up apparatus 3 which includes a flexible suction pipe 4 for delivery of litter contaminated roadside material from a roadside to a settlement tank 5. A fan 6 sucks air from the settlement tank 5 and thus applies suction to the suction pipe 4 to pick up the litter contaminated roadside material. The litter contaminated roadside material is discharged from the settlement tank 5 through an airlock 7 to a sorting station 8, being spread out on a sorting conveyor 9 at the sorting station 8. A litter separator at the sorting station 8 comprises a camera 11 mounted above the sorting conveyor 9 which is operable to detect litter within the litter contaminated roadside material on the sorting conveyor 9 and an associated pick-up arm 12 which is operable in response to the camera 11 to grab litter detected by the camera 11 and deposit the litter into an open-topped litter bin 14 located beneath the sorting conveyor 9 and projecting laterally therefrom. When a batch of roadside material on the sorting conveyor 9 is cleared of litter, the sorting conveyor 9 is indexed forward to discharge the cleaned roadside material onto a lateral discharge conveyor 16 for return to the roadside, and at the same time draw another batch of litter contaminated roadside material from the settlement tank 5 onto the sorting conveyor 9 to repeat the sorting process.

The sorting conveyor 9 has an inlet end 18 for reception of litter contaminated roadside material from the airlock 7 and an outer end 19 for discharge of cleaned roadside material onto the lateral discharge conveyor 16 for return to the roadside. A plurality of spaced-apart lamps 20 are mounted on rails 21 at opposite sides of the sorting conveyor 9 for illumination of the litter contaminated roadside material on the sorting conveyor 9 to facilitate litter identification by the camera 11.

The sorting conveyor 9 is mounted on a frame 22 which is slidably mounted on rails 23 on top of the litter bin 14 for movement between a normal operating position, as illustrated in the drawings, and an inoperative position under the airlock 7 and settlement tank 5. A slide ram 24 mounted between the frame 22 and a top of the litter bin 14 is operable to slide the sorting conveyor 9 on top of the litter bin 14. Thus, when mostly litter is being picked up by the suction pipe 4, it can be delivered directly from the settlement tank 5 through the airlock 7 into the litter bin 14, if desired.

The pick-up arm 12 is mounted on an arm support rail 30 which projects laterally from an upstanding mounting frame 31 at one side of the chassis 2, extending across and above the outer end 19 of the sorting conveyor 9 when it is in the operative position shown in the drawings. The pick-up arm 12 has an inner part 32 and an outer part 33 interconnected by an elbow pivot joint 34 for pivoting about a horizontal axis. An inner end of the inner part 32 is connected by an inner pivot joint 36 to the rail 30 for swiveling the pick-up arm 12 on the rail 30 and for pivoting the pick-up arm 12 on the rail 30. Thus, the pick-up arm 12 can be extended and retracted in three dimensions along the sorting conveyor 9 to enable a grab 37 at an outer end of the pick-up arm 12 to grip litter anywhere on the sorting conveyor 9 for removal and subsequent drop into the litter bin 14. Articulation of the pick-up arm 12 on the rail 30 allows the grab 37 to reach all of the top of the sorting conveyor 9 for litter removal.

A controller 38 for controlling operation of the apparatus 1 including the camera 11, pick-up arm 12, pick-up apparatus 3 and other machinery is mounted on the mounting frame 31.

A camera rail 40 also projects laterally from the mounting frame 31 above the inner end 19 of the sorting conveyor 9, that is, above an outlet 88 of the airlock 7. The camera 11 is directed downwardly to view material carried on the sorting conveyor 9.

A flexible outer end 41 of the suction pipe 4 is controlled by an articulated arm assembly 42. The arm 42 has an inner part 43, an intermediate part 44 and an outer part 45. A bottom of the inner part 43 is rotatably mounted on a support 46 on the chassis 2, rams 47 being operable to swivel the inner arm 43 about a vertical pivot axis. The intermediate part 44 is connected to the inner part 43 by a pivot 48. A ram 49 connected between the inner part 43 and the intermediate part 44 is operable to raise and lower the intermediate part 44 on the inner part 43. The outer part 45 is connected to the intermediate part 44 by a pivot 50, a ram 52 being operable to pivot the outer part 45 about a pivot pin 54. A slide arm 55 has an inner end which slides telescopically within the outer part 45 and an outer end attached to a mounting bracket 56 which carries a pick-up head 60.

The suction pipe 4 is supported on the intermediate part 44 by rectangular guide frames 57 attached to and projecting laterally from the intermediate part 44. Each guide frame 57 defines an opening through which the suction pipe 4 passes. Rollers 58 rotatably mounted on each side of the frame 57 within the opening engage and support the suction pipe 4.

Referring in particular to FIG. 4, the pick-up head 60 has a frustoconical or flared upper part 61 attached to an outer end of the suction pipe 4 and having an inner mounting ring 62. A lower part of the pick-up head 60 is formed by a resilient skirt 63 which depends from an outer mounting ring 64 which overlaps and slidably engages the inner mounting ring 62 and can be locked in four equally spaced-apart positions on the inner mounting ring 62 by means of locking brackets 65, 66 on the mounting rings 62, 64. The skirt 63 has an opening 68 at one side of the skirt 63 for feeding litter contaminated roadside material into the pneumatic pick-up pipe 4.

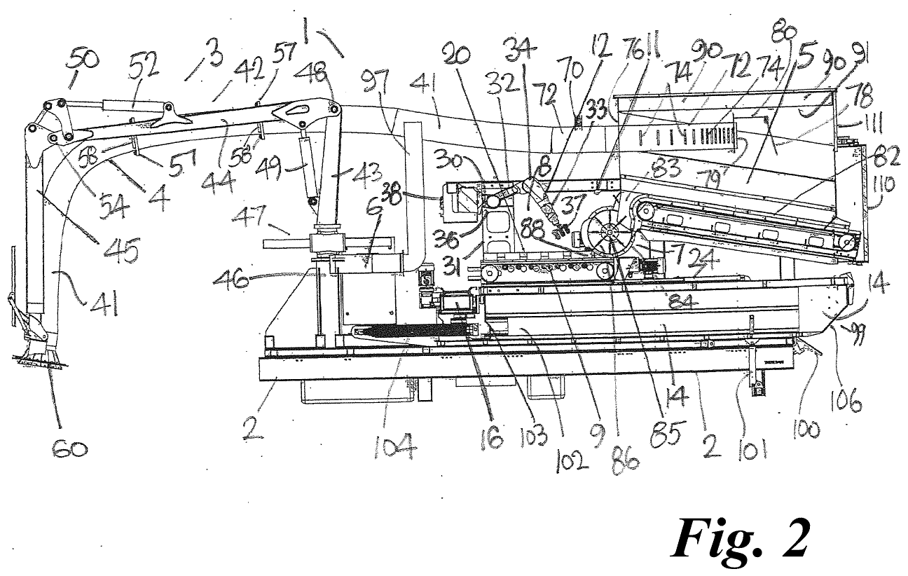

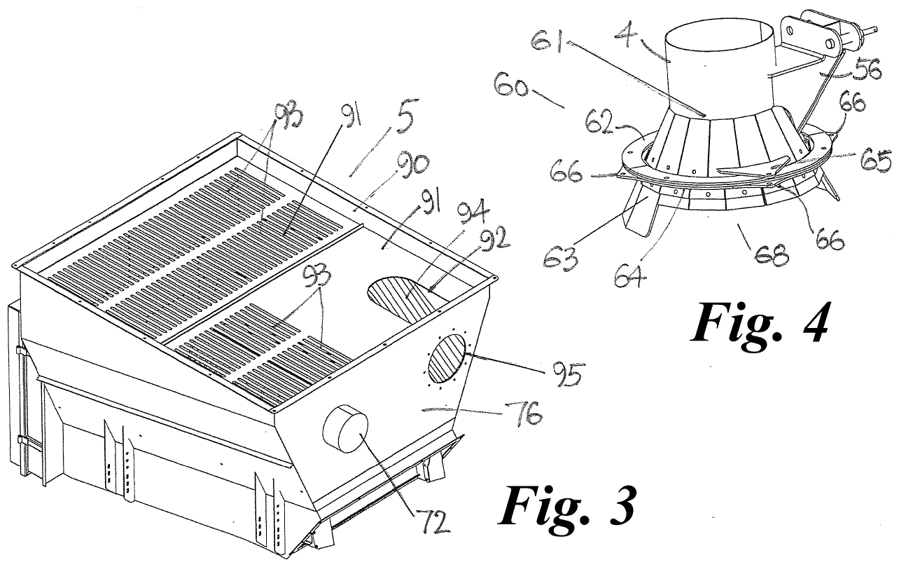

A vent valve 70 on the pick-up pipe 4 adjacent the settlement tank 5 and outside the settlement tank 5 is operable to adjust the suction within the pick-up pipe 4. Referring in particular to FIG. 2, the suction pipe 4 has a rigid inner end 72 mounted on a front wall 76 of the settlement tank 5 which extends into the settlement tank 5. A number of spaced-apart vent slots 74 are provided in a side wall of the inner end 72 within the settlement tank 5 to reduce turbulence in the material picked up by the suction pipe 4 as it enters the settlement tank 5. It will be noted that the vent slots 74 spacing decreases as the inner end 72 moves into the settlement tank 5 away from the front wall 76 of the settlement tank 5. A deflector flap 78 is mounted spaced-apart from an innermost free outlet end 79 of the suction pipe 4 on an arm 80 to deflect incoming material downwardly towards a bottom of the settlement tank 5.

A transfer conveyor 82 is mounted at a bottom of the settlement tank 5 and receives incoming litter contaminated roadside material from the suction pipe 4 and delivers this material to an inlet 83 of the airlock 7. The airlock 7 has a cylindrical housing 84 within which a central driveshaft 85 is rotatably mounted. A plurality of circumferentially spaced-apart radial vanes 86 project outwardly from the shaft 86 and sealingly engage against an inner face of the housing 84. Thus, litter contaminated roadside material is delivered from the inlet 83 to an outlet 88 of the airlock 7 for deposition onto the inlet end 18 of the sorting conveyor 9.

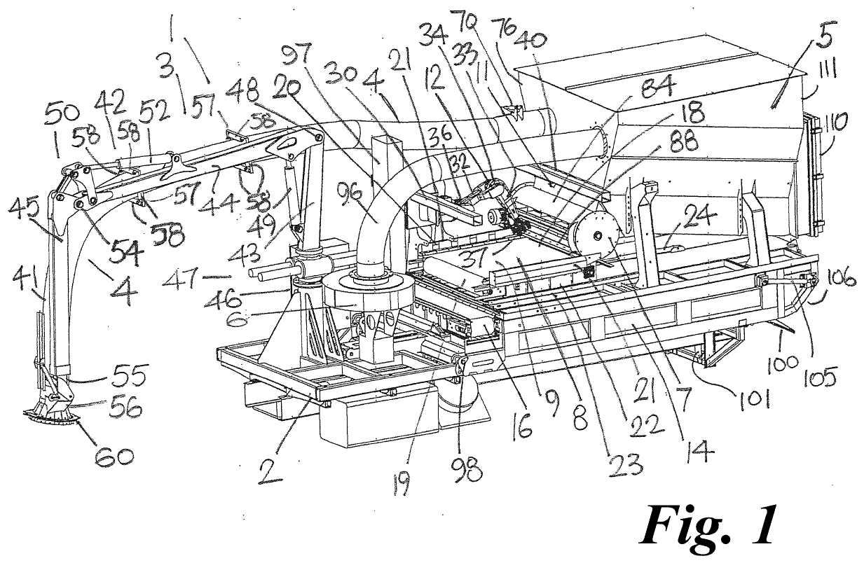

An air suction chamber 90 is provided at a top of the settlement tank 5 above a partition wall formed by a vented grille plate 91 having a plurality of spaced-apart air inlet openings or slots 93. An air outlet 92 of the air suction chamber 90 at one side of the grille plate 91 communicates via an air supply duct 94 with an outlet 95 in the front wall 76 of the settlement tank 5 to which a suction pipe 96 (FIG. 1) for the fan 6 is attached. An upstanding air outlet duct 97 from the fan 6 discharges to atmosphere. At least portion of the suction pipe 96 is flexible.

The arrangement of slots 74 in the inner end 72 of the suction pipe 4 within the settlement tank 5 reduces turbulence in the litter contaminated roadside material as it enters the settlement tank 5. The air suction chamber 90 pulls air upwardly whilst the litter contaminated roadside material deflects downwardly within the settlement tank 5.

The litter bin 14 is pivotally mounted on the chassis 2 by pivot pins 98 at opposite sides of the chassis 2 for raising and lowering a rear end 99 of the litter bin 14 by means of a tilt ram 101 mounted between the chassis 2 and the litter bin 14 at a rear end of the litter bin 14. Rams 105 at each side of the litter bin 14 are operable to open and close a discharge door 106. A deflector flap 100 is mounted across an end of the litter bin 14 beneath the discharge door 106. A litter compactor 102 is mounted within the litter bin 14 and has a plunger 103 which is movable through the litter bin 14 by an associated compactor ram 104 to compact litter within the litter bin 14.

The settlement tank 5 is mounted on top of the litter bin 14. An airtight access door 110 is provided on a rear wall 111 of the settlement tank 5. This provides access for clearing any blockages and for maintenance.

Typically, in use, the apparatus 1 is mounted on the bed of a lorry or the like vehicle or alternatively the chassis 2 could be incorporated into a mobile vehicle chassis to transport the apparatus 1 alongside a roadside for collecting litter therefrom.

In use, the apparatus 1 is driven along a roadside and the suction pipe 4 and pick-up head 60 are maneuvered to pick up litter contaminated roadside material. The fan 6 applies suction to the suction pipe 4 to suck up the litter contaminated roadside material which is discharged into the settlement tank 5. The litter contaminated roadside material drops onto the transfer conveyor 82 at the bottom of the settlement tank 5 for delivery to the airlock 7. A batch of the litter contaminated roadside material is discharged from the airlock 7 onto the sorting conveyor 9. Litter in the litter contaminated roadside material is identified by the camera 11 and the pick-up arm 12 is controlled by the camera 11 to pick up litter and drop it at either side of the sorting conveyor 9 into the open-topped litter bin 14. When the litter has been cleared, the sorting conveyor 9 is indexed forward so the remaining clean roadside material on the sorting conveyor 9 is discharged onto the lateral discharge conveyor 16 for return to the roadside. At the same time, a new batch of litter contaminated roadside material is discharged from the airlock 7 onto the sorting conveyor 9. Litter is compacted within the litter bin 14 by the compactor 102. To empty the litter bin 14, it is tilted upwardly on the chassis 2 by the tilt ram 101 to position it over a side of a skip. With the discharge door 106 open, the compactor 102 can push the litter out of the litter bin 14 and into the skip.

While an indexing sorting conveyor 9 has been described herein, it is envisaged that a continuously moving sorting conveyor 9 could alternatively be used provided the camera 11 and the associated pick-up arm 12 have sufficient time to identify and remove the litter.

Hydraulic or electric drive may be provided for the various components of the apparatus.

The terms “comprise” and “include”, and any variations thereof required for grammatical reasons, are to be considered as interchangeable and accorded the widest possible interpretation.

The invention is not limited to the embodiments hereinbefore described but may be varied in both construction and detail within the scope of the appending claims.

1. A roadside litter collecting apparatus, comprising:
a sorting station; and
a litter pick-up apparatus to collect litter contaminated roadside material from a roadside for delivery to the sorting station,
the sorting station having a litter separator which is operable to separate litter from the roadside material, deliver the litter to a litter bin and return the roadside material to the roadside;
wherein the litter separator has a camera which is operable to detect litter within the litter contaminated roadside material, and an associated litter pick-up arm which is operable in response to the camera to grab detected litter and deposit the litter in the litter bin.

2. The apparatus as claimed in claim 1, wherein the litter separator has a separator conveyor having an inlet end for reception of the litter contaminated roadside material from the litter pick-up apparatus, and an outlet end which discharges roadside material to a return conveyor for discharging roadside material back to the roadside.

3. The apparatus as claimed in claim 2, wherein a plurality of lamps are mounted at opposite sides of the separator conveyor for illuminating material on the separator conveyor.

4. The apparatus as claimed in claim 2, wherein the separator conveyor is an indexing conveyor.

5. The apparatus as claimed in claim 1, wherein the litter pick-up apparatus comprises a pneumatic pick-up pipe having an inner end which discharges into a settlement tank and a movable outer end with a pick-up head, a fan having an inlet connected to the settlement tank to apply suction to the pick-up pipe, the settlement tank having an outlet for the litter contaminated roadside material communicating with an inlet of the litter separator.

6. The apparatus as claimed in claim 5, wherein the settlement tank outlet communicates with the inlet of the litter separator through an airlock.

7. The apparatus as claimed in claim 6, wherein the airlock has a cylindrical housing, a central driveshaft rotatably mounted within the housing and having a plurality of circumferentially spaced-apart radial vanes, an outer end of each vane sealingly engaging against an inner face of the cylindrical housing to provide an airtight seal therewith.

8. The apparatus as claimed in claim 5, wherein an air suction chamber is provided in the settlement tank above the inlet end of the pneumatic pick-up pipe behind a partition wall having a plurality of spaced-apart air inlet openings, an air outlet of the air suction chamber communicating with the inlet of the fan.

9. The apparatus as claimed in claim 2, wherein the separator conveyor is movable between an operating position for reception of the litter contaminated roadside material from the settlement tank and an inoperative position wherein the litter contaminated roadside material bypasses the separator conveyor.

10. The apparatus as claimed in claim 9, wherein the separator conveyor is slidably mounted on top of the litter bin for movement between the operating position and the inoperative position.

11. The apparatus as claimed in claim 5, wherein the inner end of the pneumatic pick-up pipe extends into the settlement tank and has a number of spaced-apart vent slots in a side wall of the inner end within the settlement tank.

12. The apparatus as claimed in claim 5, wherein the pick-up head is telescopically mounted at the outer end of the pneumatic pick-up pipe.

13. The apparatus as claimed in claim 5, wherein the pick-up head is rotatably mounted at the outer end of the pneumatic pick-up pipe.

14. The apparatus as claimed in claim 5, wherein the pick-up head has a skirt of resilient material with an opening in a side of the skirt for feeding the litter contaminated roadside material into the pneumatic pick-up pipe.

15. The apparatus as claimed in claim 5, wherein an air vent is mounted on the pneumatic pick-up pipe which is operable to reduce suction in the pneumatic pick-up pipe.

16. The apparatus as claimed in claim 1, wherein the litter bin is pivotally mounted on a support frame for pivotal movement between a lowered collecting position and a tilted discharge position.

17. The apparatus as claimed in claim 1, wherein a compactor is movable through the litter bin to compact waste collected within the litter bin

18. The apparatus as claimed in claim 2, wherein the litter bin is mounted beneath the separator conveyor and projects laterally outwardly therefrom to provide a litter inlet opening at a top of the litter bin.

19. The apparatus as claimed in claim 5, wherein the settlement tank is mounted on top of the litter bin.

20. The apparatus as claimed in claim 1, wherein the roadside litter collecting apparatus is mounted on a mobile chassis.
